(19) United States
(12) Patent Application Publication
(10) Pub. No.: US 2015/0368478 A1
(43) Pub. Date: Dec. 24, 2015

(54) CORROSION INHIBITING REAGENT AND RESIN COATED BEAD WIRE

(71) Applicant: NV BEKAERT SA, Zwevegem (BE)

(72) Inventors: Yohann HAMON, Wervicq-sud (FR); Zhen WANG, Jiangsu (CN); Ying CHEN, Shanghai (CN)

(73) Assignee: NV BEKAERT SA, Zwevegem (BE)

(21) Appl. No.: 14/654,936

(22) PCT Filed: Nov. 15, 2013
(86) PCT No.: PCT/EP2013/073947

§ 371 Date: Jun. 23, 2015

(30) Foreign Application Priority Data
Dec. 26, 2012 (CN) PCT/CN2012/087517

(51) Int. Cl. C09D 5/08; C09D 7/00; D07B 1/06; C09D 145/02

(52) U.S. Cl. CPC C09D 5/086; C09D 145/02; C09D 7/001; D07B 1/0666

(57) ABSTRACT

A copper alloy coated bead wire is coated with a resin coating comprising corrosion inhibiting reagent to promote corrosion resistance and bead/rubber adhesion retention. The thin and continuous resin coating comprising corrosion inhibiting reagent is formed by applying a solvent containing both corrosion inhibiting reagent and resin on the copper alloy coated the bead wire. The thin and continuous resin coating comprising corrosion inhibiting reagent achieves synergetic effect. On one hand, the thin resin coating comprising corrosion inhibiting reagent allows a sulfur/copper bond to be formed between bead wire and the adjacent rubber. On the other hand, the continuous resin coating comprising corrosion inhibiting reagent facilitates corrosion resistance.

### TECHNICAL FIELD

The invention relates to a bead wire for pneumatic tyres, more particularly, a corrosion inhibiting coating on the copper alloy coated bead wire to prevent corrosion of the bead and to improve bead/rubber adhesion retention.

### BACKGROUND ART

A pneumatic tire generally comprises a crown that comes into contact with the ground and, on either side of the crown, a sidewall the inner edge of which, intended to be supported by the rim of a wheel, is formed by the bead. The bead has among its components at least one bead core. The latter fulfils various functions. It serves in particular as anchorage for the ply or plies forming the carcass of the tire and withstands the forces exerted on it by the carcass under the effect of the inflation pressure and the deformations resulting from the travel of the tire. The bead core also serves to ensure the transmission of longitudinal forces and, in the case of tubeless tire, to ensure a seal between the tire and the wheel rim.

There exist several types of bead cores. Rubberized bead is made by winding rubberized wires according to US1914040A or US2149079A. Cable bead is made by winding wires spirally around an annular welded core according to US1565616A or GB1100686A. All steel bead is made by winding wires with profiled cross-section into multiply turns and forming n×m packaged bead core according to U.S. Pat. No. 3,949,800 or U.S. Pat. No. 4,166,492. In all, bead core is made of bead wires, either with circular cross-section or with profiled cross-section.

Bead wires are usually copper alloy, bronze or brass, coated to promote the bead/rubber adhesion, while copper alloy coated bead wire are subject to corrosion of the steel structure and oxidation of the copper alloy coating if improperly handled prior to incorporation into a tyre. Corrosion and oxidation can result in poor adhesion between the bead and rubber and more importantly in a deterioration of the physical properties of the bead.

Prior art U.S. Pat. No. 4,192,694 discloses that brass coated steel tire cord is treated with solid or molten benzotriazole (BTA) and/or other treatment agents to promote corrosion resistance and cord to rubber adhesion retention, in which the wire either passes through the molten corrosion inhibiting reagent or passes through a solid, in powdered form, where the wire is at a temperature above the melting point of the corrosion inhibiting reagent so as to melt the solid adjacent to the surface of the wire. Prior art U.S. Pat. No. 4,269,877 further discloses that benzotriazole (BTA) and/or a precipitation compound such as cyclohexylamine borate and/or an oxidation compound such as zinc chromate can improve the vulcanized aged adhesion of rubber to clean brass coated steel cord, in which the tire cord can be dipped into an aqueous solution of BTA, precipitation compound (e.g. cyclohexylamine borate) and/or oxidation compound (e.g. zinc chromate) and dried by a blast of hot air.

The two prior arts have drawbacks. Melting BTA or heating the wire above the melting temperature of BTA consumes energy. Besides, the BTA coating on the surface of the wire is not evenly distributed, and excessive volume of BTA may cut the bead/rubber adhesion. While dipping wires into an aqueous solution of BTA takes time for the wire drying and brings a lengthy process which can be expensive in commercial operation.

### DISCLOSURE OF INVENTION

The primary object of the invention is to provide a new corrosion inhibiting coating on the copper alloy coated bead wire.

The second object of the invention is to provide simple process to apply this new corrosion inhibiting coating on the copper alloy coated bead wire.

According to one aspect of present invention, a copper alloy coated bead wire is coated with a resin coating comprising corrosion inhibiting reagent on the copper alloy coating. The corrosion inhibiting reagent means a substance which reacts with the copper alloy coating or exposed steel surface of the bead wire so as to promote and/or retain adhesion between bead wire and rubber, and/or to improve the resistance of bead wire to corrosion. The corrosion inhibiting reagent in the resin coating may amounts between 10% and 90% in weight, and preferably between 20% and 40% in weight. The resin coating comprising corrosion inhibiting reagent may be coated on the copper alloy coating in an amount corresponding to between 50 and 300 mg/m², and preferably between 150 and 200 mg/m². The corrosion inhibiting reagent can be Benzotriazole. The resin can be hydrocarbon resin or phenolic resin, and the hydrocarbon resin can be cumar resion.

According to another aspect of present invention, the method of manufacturing a copper alloy coated bead wire with resin coating comprising corrosion inhibiting reagent comprises the step of applying a solvent containing both corrosion inhibiting reagent and resion on the copper alloy coating. The solvent can be Acetone, Gasoline, Xylene, Diethylene glycol diethyl ether, Buthyl acetate, Ethyl acetate or the mixture of above. The concentration of corrosion inhibiting reagent and resin in the solvent may range between 5 g/L and 300 g/L, and preferably between 5 g/L and 50 g/L. The solvent may meet following function, Hansen solubility parameters Dblend<18, Pblend<11, Hblend<13.

### BRIEF DESCRIPTION OF FIGURES IN THE DRAWINGS

FIG. 1 schematically illustrates a magnified cross sectional view of a copper alloy coated bead wire with resin coating comprising corrosion inhibiting reagent.

FIG. 2 schematically illustrates a magnified cross sectional view of a portion of a copper alloy coated bead wire with resin coating comprising corrosion inhibiting reagent.

### MODE(S) FOR CARRYING OUT THE INVENTION

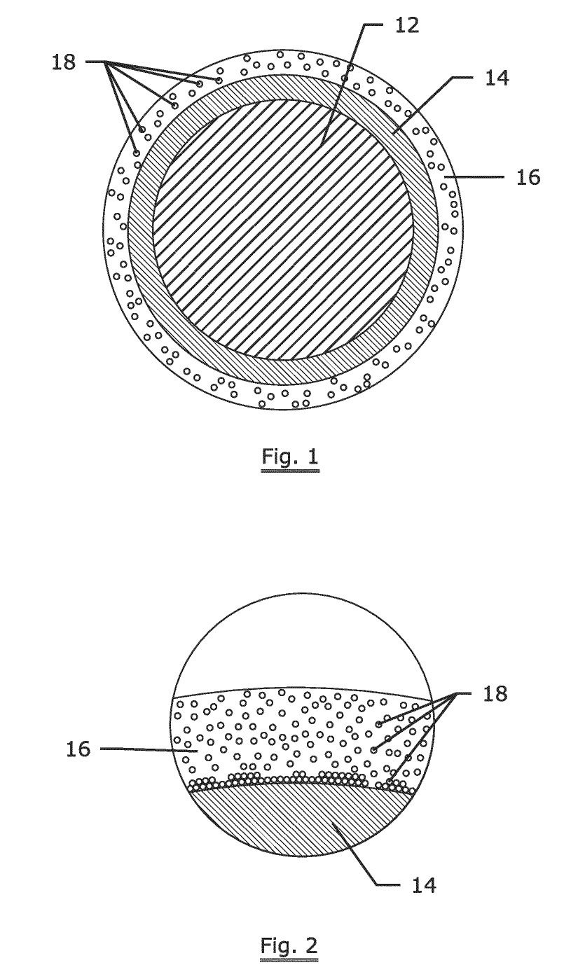

FIG. 1 schematically illustrates a magnified cross sectional view of a copper alloy coated bead wire with resin coating comprising corrosion inhibiting reagent. A bead wire 10 incorporating present invention comprises, a steel wire 12, a copper alloy coating 14 on the surface of steel wire 12, a resin coating 16 comprising corrosion inhibiting reagent on the surface of copper alloy coating 14, wherein corrosion inhibiting reagent molecules 18 are distributed in resin coating 16. In this figure, the resin coating 16 comprising corrosion inhibiting reagent forms a thin and continuous layer on the copper alloy coating 14 of the bead wire 10.

The corrosion inhibiting reagent reacts with the copper alloy coating or exposed steel surface of the bead wire so as to promote and/or retain adhesion between bead wire and rubber, and/or to improve the resistance of bead wire to corrosion. For example, BTA reacts with the copper to form a polymer layer to protect bead wire from exterior environment. The corrosion inhibiting reagent includes, but not limited to, corrosion inhibiting reagent selected from the group consisting of precipitation compounds, oxidizing compounds, and compounds having the following structural formula

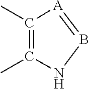

wherein the adjacent carbon atoms are joined to form a benzene or naphthylene ring, said ring being substituted (for example, with a single methyl group) or un-substituted and wherein A and B are selected from the group consisting of —N— or —CH—, with the proviso that A and B are never both —CH—, said agent being in the form of a solid or a liquid. The precipitation compounds include compounds selected from the group consisting of organic borates, organic phosphate and organic meta-phosphates. The oxidation compounds include organic nitrites. The precipitation compounds offer their protection through an indirect oxidizing (buffering) mechanism. The oxidation compounds offer protection by directly oxidizing metallic ions in the substrate surface. Examples of organic compounds which can be used in the practice of present invention include organic alkyl, cycloalkyl and aryl derivatives of m-boric acid, o-boric acid and pyro-boric acid as well as m-, o-, pyro- and hypo-phosphoric acid.

FIG. 2 schematically illustrates a magnified cross sectional view of a portion of a copper alloy coated bead wire with resin coating comprising corrosion inhibiting reagent. The resin coating 16 is coated on the copper alloy coating 14, while corrosion inhibiting reagent molecules 18 are distributed in resin coating 16. Since the corrosion inhibiting reagent molecules 18 can react with copper alloy coating, there are more corrosion inhibiting reagent molecules 18 on the surface of copper alloy coating 14 than those in the resin coating 16. The condensed corrosion inhibiting reagent molecules 18 on the surface of copper alloy coating 14 may form a layer of corrosion inhibiting reagent molecules 18, and more preferably, the layer of corrosion inhibiting reagent molecules 18 can form a continuous layer to cover the surface the copper alloy coating 14.

The resin can be hydrocarbon resin or phenolic resin. Hydrocarbon resin includes coumarone-indene resins, petroleum resins, terpene resins, bitumens, tar and copolymers, e.g., high styrene reinforcement polymers and Rosins, their salts, esters and other derivatives. Phenolic resin includes various kinds like alkylphenol/formaldehyde resins, alkylphenol and acetylene condensation products, lignin and modifications thereof to name a few.

The method of manufacturing a copper alloy coated bead wire with resin coating comprising corrosion inhibiting reagent comprises the step of applying a solvent containing both corrosion inhibiting reagent and resion on the copper alloy coating. The solvent can be Acetone, Gasoline, Xylene, Diethylene glycol diathyl ether, Buthyl acetate, Ethyl acetate or the mixture of above. Since the above solvent are volatile, a thin and continuous resin coating comprising corrosion inhibiting reagent can be formed on the copper alloy coating of the bead wire fastly. This resin coating comprising corrosion inhibiting reagent brings synergetic effect. On one hand, the thin resin coating comprising corrosion inhibiting reagent allows a sulfur/copper bond to be formed between bead wire and the adjacent rubber. On the other hand, the continuous resin coating comprising corrosion inhibiting reagen facilitates corrosion resistance. Compared with the corrosion inhibiting reagent coating applied in an aqueous solution, the resin coating comprising corrosion inhibiting reagent in present invention improves corrosion resistance because the even and continuous resin coating provides extra protection from exterior environment. Compared with corrosion inhibiting reagent coating applied through a molten or meltable solid corrosion inhibiting reagent, resin coating comprising corrosion inhibiting reagent in present invention is thin and even, while the corrosion inhibiting reagent coating according to prior art is thick and un-even with excessive volume of corrosion inhibiting reagent. To maintain the synergetic effect of this resin coating comprising corrosion inhibiting reagent, the corrosion inhibiting reagent in the resin coating amounts between 10% and 90% in weight, and preferably between 20% and 40% in weight. The resin coating comprising corrosion inhibiting reagent is coated on the copper alloy coating in an amount corresponding to between 50 and 300 mg/m², and preferably between 150 and 200 mg/m². The concentration of corrosion inhibiting reagent and resin in the solvent ranges between 5 g/L and 300 g/L, and preferably between 5 g/L and 50 g/L.

A comparison test between present invention and prior arts also confirms the synergetic effect of this resin coating comprising corrosion inhibiting reagent on bead/rubber adhesion and corrosion resistance.

| | Bead/rubber adhesion | Corrosion resistance |
|---|---|---|
| Reference 1 | 63% | 79% |
| Reference 2 | 81% | 62% |
| Present invention | 100% | 100% |

Wherein reference 1 is a copper alloy coated bead wire with BTA coating applied by passing through a molten BTA according to U.S. Pat. No. 4,192,694.

Reference 2 is a copper alloy coated bead wire with BTA coating applied in an aqueous solution according to U.S. Pat. No. 4,269,877. Present invention is a copper alloy coated bead wire with resin coating comprising BTA by applying a solvent containing both BTA and cumar resin according to present invention.

The solvent used according to this invention is comprised of a hydrocarbon mixture. The solvent can be comprised of at least 1 hydrocarbon, or of a mixture of 2 or more different hydrocarbons. Hydrocarbon according to this invention refers to any chemicals compound that comprised at least one hydrogen and one carbon atom covalently bonded to one another (C—H). Suitable solvent for use according to this invention can be classified according to Hansen solubility parameters, which is the three component set of parameters that takes into account a compound's dispersion force, polarity, and hydrogen bonding force. The Hansen solubility parameters are each defined as a dispersion parameter (D), a polarity parameter (P), and an hydrogen bonding parameter (H). These parameters are listed for numerous compounds and can be found in literatures. The solvent mixture (=solvent blend) is designed so that it has the desired Hansen solubility parameters that allows a good solvation of the coating ingredients.

According to the Hansen solubility parameters system, a mathematical mixing rule can be applied in order to derive or calculate the respective Hansen parameters for a blend of hydrocarbons from knowledge of the respective parameters of each hydrocarbon component and the volume faction of the hydrocarbon component. Thus according to this mixing rule:

Dblend=ΣViDi,

Pblend=ΣViPi,

Hblend=ΣViHi,

Where Dblend is the Hansen dispersion parameter of the blend, Di is the Hansen dispersion parameter for component i in the blend; Pblend is the Hansen polarity parameter of the blend, Pi is Hansen polarity parameter for component i in the blend; Hblend is the Hansen hydrogen bonding parameter for the blend, Hi is the Hansun hydrogen bonding parameter for component i in the blend; Vi is the volume fraction for component i in the blend, and summation is over all i components in the blend.

The solvent of this invention is defined according to the mathematical mixing rule. The solvent is comprised of a blend of hydrocarbon compounds and can optionally include limited amounts of non-hydrocarbon compounds. In such cases when non-hydrocarbon compounds are included in the solvent, the Hansen solubility parameters of the non-hydrocarbon compounds should also be taken into account according to the mathematical mixing rule. Thus, the Hansen solubility blend parameters can be determined according to “Hansen solubility parameters in practice”, e.g. chapter 3 page 15-18 and chapter 8 page 43-46 for further description.

The Hansen solubility parameters for the solvent mixture usable for present invention meet following function.

Dblend<18,

Pblend<11,

Hblend<13.

The solvent, which can be a component of the solvent mixture for present invention, and the Hansen solubility parameters are listed below.

| | | | Hydrogen |
|---|---|---|---|
| | Dispersion | Polarity | bonding |
| Acetone | 15.5 | 10.4 | 7 |
| Xylene (o-) | 17.8 | 1 | 3.1 |
| Pentane | 14.5 | 0 | 0 |
| Diethylene glycol diethyl ether | 15.8 | 5.9 | 5.6 |
| Diethylene glycol monomethyl ether | 16.2 | 7.8 | 12.6 |
| Diethyl carbonate | 15.1 | 6.3 | 3.5 |
| Tert-butyl methyl ether | 14.8 | 4.3 | 5 |
| Buthyl acetate | 15.8 | 3.7 | 6.3 |
| Ethyl acetate | 15.8 | 5.3 | 7.2 |

1.-13. (canceled)

14. A bead wire with copper alloy coating, wherein said bead wire is coated with a resin coating comprising a corrosion inhibiting reagent, on the copper alloy coating.

15. A bead wire with copper alloy coating as claimed in claim 14, wherein said corrosion inhibiting reagent in said resin coating amounts between 10% and 90% in weight.

16. A bead wire with copper alloy coating as claimed in claim 15, wherein said corrosion inhibiting reagent in said resin coating amounts between 20% and 40% in weight.

17. A bead wire with copper alloy coating as claimed in claim 14, wherein said resin coating comprising corrosion inhibiting reagent is coated on the copper alloy coating in an amount corresponding to between 50 and 300 mg/m².

18. A bead wire with copper alloy coating as claimed in claim 17, wherein said resin coating comprising corrosion inhibiting reagent is coated on the copper alloy coating in an amount corresponding to between 150 and 200 mg/m².

19. A bead wire with copper alloy coating as claimed in claim 14, wherein said corrosion inhibiting reagent is Benzotriazole.

20. A bead wire with copper alloy coating as claimed in claim 14, wherein said resin is hydrocarbon resin or phenolic resin.

21. A bead wire with copper alloy coating as claimed in claim 20, wherein said hydrocarbon resin is Cumar resin.

22. A method of manufacturing a copper alloy coated head wire with resin coating comprising corrosion inhibiting reagent, comprising the step of applying a solvent containing both corrosion inhibiting reagent and resin on the copper alloy coating.

23. A method of manufacturing a copper alloy coated bead wire with resin coating comprising corrosion inhibiting reagent as claimed in claim 22, wherein said solvent is Acetone, Gasoline, Xylene, Diethylene glycol diethyl ether, Buthyl acetate, Ethyl acetate, or the mixture of above.

24. A method of'manufacturing a copper alloy coated bead wire with resin coating comprising corrosion inhibiting reagent as claimed in claim 22, wherein the concentration of corrosion inhibiting reagent and resin in said solvent ranges between 5 g/L and 300 g/L.

25. A method of manufacturing a copper alloy coated head wire with resin coating comprising corrosion inhibiting reagent as claimed in claim 24, wherein the concentration of corrosion inhibiting reagent and resin in said solvent ranges between 5 g/L and 50 g/L.

26. A method of manufacturing a copper alloy coated bead wire with resin coating comprising corrosion inhibiting reagent as claimed in claim 22, wherein said solvent meets following function, Hansen solubility parameters Dblend<18, Pblend<11, Hblend<13.
